(19) United States
(12) Patent Application Publication
(10) Pub. No.: US 2026/0092900 A1
(43) Pub. Date: Apr. 2, 2026

(54) ULTRASOUND PROBE

(71) Applicant: FUJIFILM Corporation, Tokyo (JP)

(72) Inventors: Rika TASHIRO, Kanagawa (JP); Shinsuke NOGUCHI, Kanagawa (JP); Tomoki INOUE, Tokyo (JP)

(73) Assignee: FUJIFILM Corporation, Tokyo (JP)

(21) Appl. No.: 19/320,367

(22) Filed: Sep. 5, 2025

(30) Foreign Application Priority Data
Sep. 30, 2024 (JP) 2024-170046

(51) Int. Cl. G01N 29/24; G01N 29/22

(52) U.S. Cl. CPC G01N 29/2418; G01N 29/226; G01N 29/2481; G01N 2291/106

(57) ABSTRACT

Provided is a wireless-connection ultrasound probe that can easily grasp an operation state.

A housing includes a head portion that accommodates a transducer array, and a grip portion that is connected to the head portion and that is gripped by a user, a protrusion for indicating an orientation of an ultrasound probe is disposed on an outer side surface of the head portion, a light-emitting unit is disposed on an outer side surface of the grip portion on the same side as the outer side surface of the head portion on which the protrusion is disposed, and a light emission controller controls the light-emitting unit to perform light emission in a way in accordance with an operation state of the ultrasound probe.

### CROSS-REFERENCE TO RELATED APPLICATIONS

The present application claims priority under 35 U.S.C. § 119 to Japanese Patent Application No. 2024-170046, filed on Sep. 30, 2024. The above application is hereby expressly incorporated by reference, in its entirety, into the present application.

### BACKGROUND OF THE INVENTION

### 1. Field of the Invention

The present invention relates to an ultrasound probe, and particularly to a wireless-connection ultrasound probe.

### 2. Description of the Related Art

In related art, an ultrasound diagnostic apparatus using ultrasound images is put into practical use in the medical field. In general, such an ultrasound diagnostic apparatus comprises an ultrasound probe in which a transducer array is built and an apparatus body connected to the ultrasound probe, in which an ultrasound image is generated by transmitting an ultrasound beam from the ultrasound probe toward a subject, receiving an ultrasound echo from the subject by the ultrasound probe, and electrically processing the received signal, for example, in the apparatus body.

In recent years, as disclosed in JP2022-164871A, an ultrasound diagnostic apparatus in which a battery is built in an ultrasound probe, and the ultrasound probe and an apparatus body are wirelessly connected to each other by wireless communication has been developed. In such an ultrasound diagnostic apparatus, a cable for connecting the ultrasound probe and the apparatus body is not required, so that the operability and mobility of the ultrasound probe by a user in a case performing ultrasound diagnosis can be improved.

However, since the wireless-connection ultrasound probe does not have a cable for connecting the ultrasound probe and the diagnostic apparatus body, it is considered that the ultrasound probe is freely gripped in various ways. As a result, for example, in a case in which the front and back sides of the ultrasound probe are mistakenly recognized during use, there is a concern that normal ultrasound diagnosis cannot be performed. Therefore, an ultrasound probe having a protrusion for indicating an orientation on an outer surface of a housing may be used, but it is desirable to be able to grasp not only the orientation of the ultrasound probe but also a state related to an operation of the ultrasound probe.

In addition, JP2023-169510A discloses an ultrasound probe that is used in a case in which a biopsy needle is inserted into a body of a subject, in which a guide portion that guides a puncture position of the biopsy needle by light emission is disposed in a housing. With this ultrasound probe, the user can grasp the puncture position of the biopsy needle by checking the guide portion, but cannot grasp an operation state of the ultrasound probe.

### SUMMARY OF THE INVENTION

The present invention has been made in order to solve such a problem in the related art, and an object of the present invention is to provide a wireless-connection ultrasound probe that can easily grasp an operation state.

The above object can be achieved with the following configurations.

[1] An ultrasound probe as a wireless-connection ultrasound probe, the ultrasound probe comprising: a transducer array; a light-emitting unit; a light emission controller that controls light emission performed by the light-emitting unit; a battery that supplies power to the light-emitting unit and the light emission controller; and a housing that accommodates the transducer array, the light emission controller, and the battery, in which the housing includes a head portion that accommodates the transducer array, and a grip portion that is connected to the head portion and that is gripped by a user, a protrusion for indicating an orientation of the ultrasound probe is disposed on an outer side surface of the head portion, the light-emitting unit is disposed on an outer side surface of the grip portion on the same side as the outer side surface of the head portion on which the protrusion is disposed, and the light emission controller controls the light-emitting unit to perform the light emission in a way in accordance with an operation state of the ultrasound probe.

[2] The ultrasound probe according to [1], in which the light emission controller changes a color of light emitted from the light-emitting unit in accordance with the operation state of the ultrasound probe.

[3] The ultrasound probe according to [2], in which the light emission controller causes the light-emitting unit to emit light of a primary color system during imaging standby and light of a complementary color system during imaging.

[4] The ultrasound probe according to [1], in which the light emission controller changes a light emission pattern in the light-emitting unit in accordance with the operation state of the ultrasound probe.

[5] The ultrasound probe according to [4], in which the light emission controller changes the light emission pattern in the light-emitting unit between a live mode and a freeze mode of imaging.

[6] The ultrasound probe according to any one of [1] to [5], in which a portion of the grip portion in which the light-emitting unit is disposed has a width narrower than a width of the head portion.

[7] The ultrasound probe according to [1], in which the housing is formed of a front-side half member and a rear-side half member that are bonded to each other, and the light-emitting unit consists of a separate component from the front-side half member and the rear-side half member and is disposed at a boundary portion between the front-side half member and the rear-side half member.

[8] The ultrasound probe according to [1], in which the housing is formed of a front-side half member and a rear-side half member that are bonded to each other, and the light-emitting unit is integrally formed with one of the front-side half member or the rear-side half member.

[9] The ultrasound probe according to [1], further comprising: an integrated circuit that performs transmission and reception of ultrasound waves using the transducer array, in which the integrated circuit is accommodated in the housing and is operated by the power supplied from the battery.

The ultrasound probe comprises: the transducer array; the light-emitting unit; the light emission controller that controls the light emission performed by the light-emitting unit; the battery that supplies the power to the light-emitting unit and the light emission controller; and the housing that accommodates the transducer array, the light emission controller, and the battery, the housing includes the head portion that accommodates the transducer array, and the grip portion that is connected to the head portion and that is gripped by the user, the protrusion for indicating the orientation of the ultrasound probe is disposed on the outer side surface of the head portion, the light-emitting unit is disposed on the outer side surface of the grip portion on the same side as the outer side surface of the head portion on which the protrusion is disposed, and the light emission controller controls the light-emitting unit to perform the light emission in a way in accordance with the operation state of the ultrasound probe, so that it is possible to easily grasp the operation state.

### BRIEF DESCRIPTION OF THE DRAWINGS

FIG. 1 is a perspective view showing an ultrasound probe according to a first embodiment of the present invention.

FIG. 2 is a plan view showing the ultrasound probe according to the first embodiment of the present invention.

FIG. 3 is a side view showing the ultrasound probe according to the first embodiment of the present invention.

FIG. 4 is a cross-sectional view showing an internal configuration of the ultrasound probe according to the first embodiment of the present invention.

FIG. 5 is a block diagram showing a configuration of an ultrasound diagnostic apparatus comprising the ultrasound probe according to the first embodiment of the present invention.

FIG. 6 is a block diagram showing an internal configuration of a transmission/reception circuit of the ultrasound probe according to the first embodiment of the present invention.

FIG. 7 is a block diagram showing an internal configuration of an image generation unit of the ultrasound probe according to the first embodiment of the present invention.

FIG. 8 is a side view showing a front-side half member and a rear-side half member constituting a housing of the ultrasound probe and a light-emitting unit in the first embodiment of the present invention.

FIG. 9 is a side view showing a front-side half member and a rear-side half member constituting a housing of the ultrasound probe and a light-emitting unit in a modification example of the first embodiment of the present invention.

FIG. 10 is a block diagram showing a configuration of an ultrasound diagnostic apparatus comprising an ultrasound probe according to a second embodiment of the present invention.

### DESCRIPTION OF THE PREFERRED EMBODIMENTS

Hereinafter, embodiments of the present invention will be described with reference to the drawings.

The following configuration requirements are described based on representative embodiments of the present invention, but the present invention is not limited to the embodiment.

In the present specification, a numerical range represented by “to” means a range including numerical values described before and after “to”, both ends inclusive, as lower limit and upper limit values.

In the present specification, “same” and “identical” include an error range which is generally allowed in the technical field.

### First Embodiment

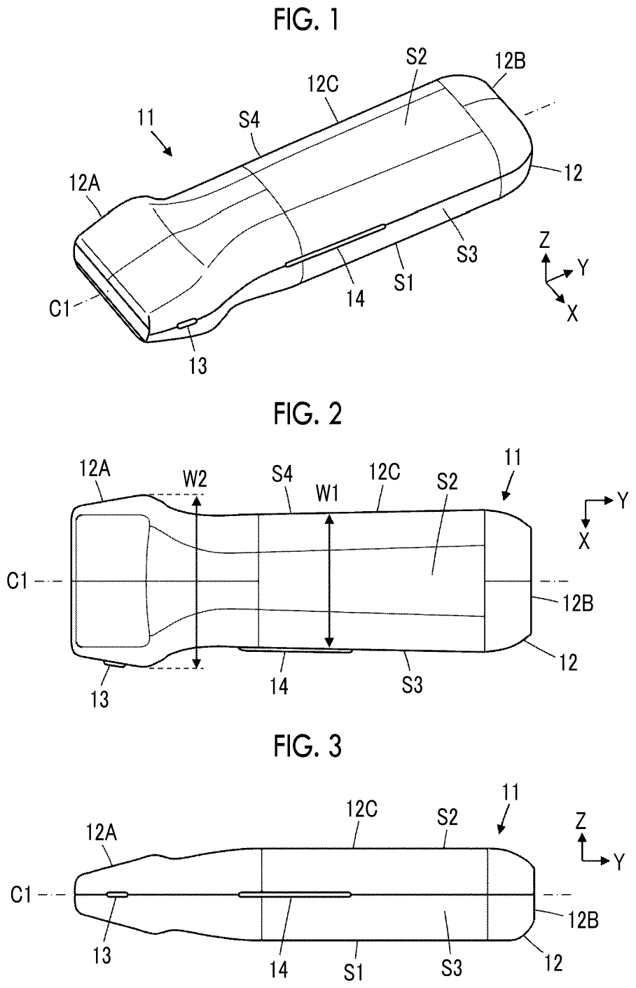

FIGS. 1 to 3 show an ultrasound probe 11 according to a first embodiment of the present invention. The ultrasound probe 11 comprises a housing 12, and the housing 12 extends in one direction as a whole and has a flat and wide shape. The housing 12 has a head portion 12A disposed at one end portion in an extending direction, a rear end portion 12B disposed at the other end portion, and a grip portion 12C disposed between the head portion 12A and the rear end portion 12B. The head portion 12A is a portion directed toward a body surface of a subject in a case of performing ultrasound diagnosis using the ultrasound probe 11, and the grip portion 12C is a portion in which the ultrasound probe 11 is gripped by a user.

Here, for convenience, a direction from the head portion 12A toward the rear end portion 12B will be referred to as a +Y direction, a width direction of the flat and wide housing 12 that is perpendicular to a Y direction will be referred to as an X direction, and a direction perpendicular to both the X direction and the Y direction will be referred to as a Z direction.

The housing 12 is made of, for example, an insulating resin, and the grip portion 12C has a width W1 narrower than a maximum width W2 of the head portion 12A in the X direction. In addition, the grip portion 12C has a tubular shape surrounded by four side plate portions each extending along a center line C1 extending from the head portion 12A to the rear end portion 12B. The four side plate portions are composed of a first side plate portion S1 directed in a −Z direction, a second side plate portion S2 directed in a +Z direction on a side opposite to the first side plate portion S1, a third side plate portion S3 connecting the first side plate portion S1 and the second side plate portion S2 and directed in a +X direction, and a fourth side plate portion S4 connecting the first side plate portion S1 and the second side plate portion S2 and directed in a −X direction.

These four side plate portions may be formed by combining a plurality of side plate members.

As shown in FIG. 3, the housing 12 has an outer shape in which a thickness in the Z direction gradually decreases from a vicinity of a center portion in the Y direction toward the head portion 12A along the center line C1, although there is a slight protrusion portion in a case of being viewed in the X direction.

In addition, a protrusion 13 for indicating an orientation of the ultrasound probe 11 is formed to protrude on the +X direction side of the head portion 12A, and a light-emitting unit 14 extending in an elongated shape in the Y direction along the center line C1 is disposed on an outer surface of the third side plate portion S3.

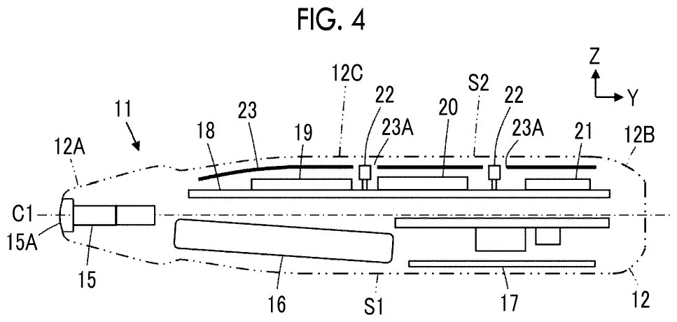

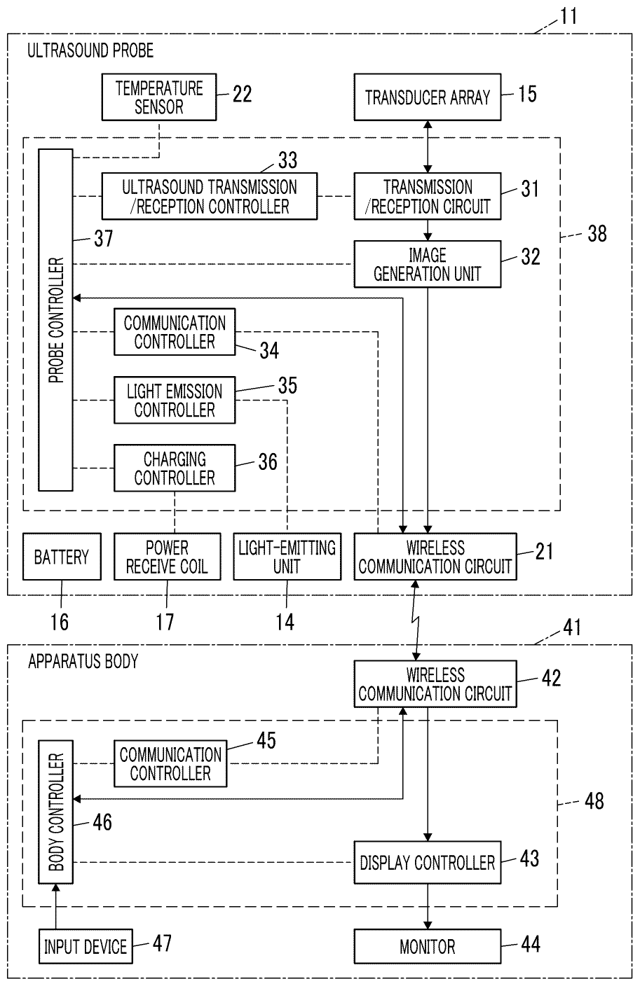

FIG. 4 shows an internal configuration of the ultrasound probe 11.

A transducer array 15 is disposed inside the head portion 12A of the ultrasound probe 11. The transducer array 15 includes a plurality of transducers arranged in the X direction and an acoustic lens 15A, and the acoustic lens 15A of the transducer array 15 is exposed from the housing 12 and directed in the −Y direction.

A flat plate-shaped battery 16 is disposed inside the housing 12 at a position offset toward the head portion 12A side from the grip portion 12C so as to lie along an inner surface of the housing 12. The battery 16 is disposed to be offset toward the −Z direction side with respect to the center line C1.

As described above, since the housing 12 has the outer shape in which the thickness in the Z direction gradually decreases from the vicinity of the center portion in the Y direction toward the head portion 12A along the center line C1, the battery 16 is disposed at a position offset toward the head portion 12A side from the grip portion 12C so as to lie along the inner surface of the housing 12, so that the battery 16 is in a state of being inclined relative to the center line C1.

A power receive coil 17 is disposed on the +Y direction side of the battery 16 at a position offset toward the −Z direction side with respect to the center line C1. The power receive coil 17 has a thinner flat plate shape than the battery 16 and is disposed along an inner surface of the first side plate portion S1 of the grip portion 12C. Here, at least a region of the first side plate portion S1 in which the power receive coil 17 is disposed has a planar inner surface and a planar outer surface, and the power receive coil 17 is disposed in a state of being in contact with the inner surface of the first side plate portion S1 or being extremely close to the inner surface of the first side plate portion S1.

In addition, inside the housing 12, a circuit board 18 is disposed at a position offset toward a side opposite to the battery 16 and the power receive coil 17 with respect to the center line C1, that is, inside the second side plate portion S2 of the grip portion 12C. The circuit board 18 extends from the grip portion 12C to the vicinity of the transducer array 15 of the head portion 12A along an XY plane, and two integrated circuits 19 and 20 and a wireless communication circuit 21 are sequentially mounted on a front surface of the circuit board 18 on the +Z direction side along the center line C1 in the +Y direction.

Furthermore, two temperature sensors 22 connected to the circuit board 18 are disposed inside the housing 12. Among the two temperature sensors 22, one temperature sensor 22 is located between the two integrated circuits 19 and 20, and the other temperature sensor 22 is located between the integrated circuit 20 and the wireless communication circuit 21, and each of the temperature sensors 22 is disposed close to an inner surface of the second side plate portion S2 of the grip portion 12C.

In addition, a sheet-like heat dissipation member 23 is disposed between the circuit board 18 and the inner surface of the second side plate portion S2 of the grip portion 12C, and the two integrated circuits 19 and 20 and the wireless communication circuit 21 mounted on the circuit board 18 are covered with the heat dissipation member 23. The heat dissipation member 23 consists of, for example, a resin sheet in which the thermal conductivity is improved by encapsulating a high thermal conductive filler, and efficiently absorbs heat from the integrated circuits 19 and 20 and the wireless communication circuit 21, which are heat generating bodies during operation, to prevent malfunction and failure of the integrated circuits 19 and 20 and the wireless communication circuit 21 from occurring in advance.

However, the heat dissipation member 23 has two opening portions 23A formed corresponding to positions at which the two temperature sensors 22 are disposed, and the two temperature sensors 22 face the inner surface of the second side plate portion S2 through the corresponding opening portions 23A of the heat dissipation member 23.

Hereinafter, FIG. 5 shows a configuration of an ultrasound diagnostic apparatus comprising the ultrasound probe 11 according to the first embodiment. The ultrasound diagnostic apparatus comprises the ultrasound probe 11 and an apparatus body 41 according to the first embodiment, and the ultrasound probe 11 and the apparatus body 41 are connected to each other by wireless communication.

The ultrasound probe 11 has a transmission/reception circuit 31 connected to the transducer array 15, and an image generation unit 32 and the wireless communication circuit 21 are sequentially connected to the transmission/reception circuit 31. In addition, an ultrasound transmission/reception controller 33 is connected to the transmission/reception circuit 31. Further, a communication controller 34 is connected to the wireless communication circuit 21, a light emission controller 35 is connected to the light-emitting unit 14, and a charging controller 36 is connected to the power receive coil 17. In addition, a probe controller 37 is connected to the temperature sensors 22, the ultrasound transmission/reception controller 33, the communication controller 34, the light emission controller 35, and the charging controller 36. The power receive coil 17 is connected to the battery 16. Here, the wireless communication circuit 21 and the probe controller 37 are connected to each other so as to enable bidirectional exchange of information.

Further, a processor 38 on the ultrasound probe 11 side is formed by the transmission/reception circuit 31, the image generation unit 32, the ultrasound transmission/reception controller 33, the communication controller 34, the light emission controller 35, the charging controller 36, and the probe controller 37.

The apparatus body 41 comprises a wireless communication circuit 42, and a display controller 43 and a monitor 44 are sequentially connected to the wireless communication circuit 42. In addition, a communication controller 45 is connected to the wireless communication circuit 42, and a body controller 46 is connected to the wireless communication circuit 42, the display controller 43, and the communication controller 45. In addition, an input device 47 is connected to the body controller 46. Here, the wireless communication circuit 42 and the body controller 46 are connected to each other so as to enable bidirectional exchange of information.

Further, a processor 48 on the apparatus body 41 side is formed by the display controller 43, the communication controller 45, and the body controller 46.

In addition, the wireless communication circuit 21 of the ultrasound probe 11 and the wireless communication circuit 42 of the apparatus body 41 are connected to each other so as to enable bidirectional exchange of information, so that the ultrasound probe 11 and the apparatus body 41 are connected to each other by wireless communication.

The transducer array 15 of the ultrasound probe 11 includes a plurality of transducers arranged in a one-dimensional or two-dimensional manner. Each of these transducers transmits ultrasound waves in accordance with a drive signal supplied from the transmission/reception circuit 31, receives an ultrasound echo from a subject, and outputs a received signal. Each transducer is formed by, for example, forming electrodes on both ends of a piezoelectric body consisting of a piezoelectric single crystal represented by lead zirconate titanate (PZT), a polymeric piezoelectric element represented by poly vinylidene di fluoride (PVDF), or a piezoelectric single crystal represented by lead magnesium niobate-lead titanate (PMN-PT) solid solution.

The ultrasound transmission/reception controller 33 controls the transmission/reception circuit 31 to transmit an ultrasound beam and receive the ultrasound echo based on an instruction from the probe controller 37.

The transmission/reception circuit 31 transmits the ultrasound waves from the transducer array 15 and generates a sound ray signal based on the received signal acquired by the transducer array 15, under the control of the ultrasound transmission/reception controller 33. The transmission/reception circuit 31 includes, as shown in FIG. 6, a pulser 51 connected to the transducer array 15, and an amplifying unit 52, an analog-digital (AD) conversion unit 53, and a beam former 54 which are sequentially connected in series to the transducer array 15.

The pulser 51 includes, for example, a plurality of pulse generators, and supplies each of drive signals to the plurality of transducers by adjusting a delay amount such that the ultrasound waves transmitted from the plurality of transducers of the transducer array 15 form an ultrasound beam based on a transmission delay pattern selected in response to a control signal from the ultrasound transmission/reception controller 33. As described above, in a case in which a pulsed or continuous wave voltage is applied to the electrodes of the transducers of the transducer array 15, the piezoelectric body expands and contracts to generate a pulsed or continuous wave ultrasound wave from each transducer, and the ultrasound beam is formed from the combined wave of these ultrasound waves.

The transmitted ultrasound beam is reflected by a target, for example, a part of the subject, and an ultrasound echo propagates toward the transducer array 15 of the ultrasound probe 11. The ultrasound echo propagating toward the transducer array 15 in this manner is received by each of the transducers constituting the transducer array 15. In such a case, each transducer constituting the transducer array 15 expands and contracts by receiving the propagating ultrasound echo to generate the received signal that is an electric signal, and outputs the received signal to the amplifying unit 52.

The amplifying unit 52 amplifies the signal input from each of the transducers constituting the transducer array 15 and transmits the amplified signal to the AD conversion unit 53. The AD conversion unit 53 converts the signal transmitted from the amplifying unit 52 into digital reception data, and transmits the reception data to the beam former 54. The beam former 54 performs so-called reception focus processing by giving and adding delay with respect to each reception data converted by the AD conversion unit 53, in accordance with a sound velocity or a sound velocity distribution set based on a reception delay pattern selected in accordance with a control signal from the ultrasound transmission/reception controller 33. By the reception focus processing, each reception data, which is converted by the AD conversion unit 53, is phase-added, and the sound ray signal in which the focus of the ultrasound echo is narrowed down is generated. The sound ray signal generated in this way is sent to the image generation unit 32.

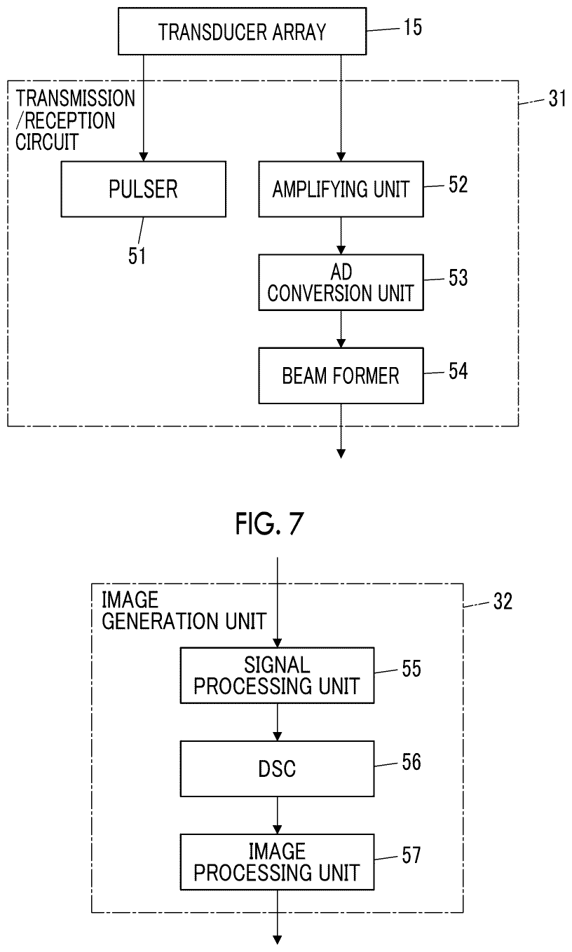

As shown in FIG. 7, the image generation unit 32 has a configuration in which a signal processing unit 55, a digital scan converter (DSC) 56, and an image processing unit 57 are sequentially connected in series.

The signal processing unit 55 performs correction of attenuation due to a distance in accordance with a depth of a reflection position of the ultrasound waves on the sound ray signal sent from the transmission/reception circuit 31, and then performs envelope detection processing to generate an image signal (B-mode image signal) which is tomographic image information related to a tissue in the subject.

The DSC 56 converts (raster-converts) the image signal generated by the signal processing unit 55 into an image signal in accordance with a normal television signal scanning method.

The image processing unit 57 performs various types of necessary image processing, such as brightness correction, gradation correction, sharpness correction, and color correction, on the image signal input from the DSC 56, to generate an ultrasound image signal. The ultrasound image signal generated by the image generation unit 32 in this way is sent to the wireless communication circuit 21.

The wireless communication circuit 21 includes an antenna for transmitting and receiving radio waves, and performs wireless communication with the wireless communication circuit 42 of the apparatus body 41. In this case, the wireless communication circuit 21 modulates a carrier based on the image signal sent from the image generation unit 32 to generate a transmission signal, and wirelessly transmits the generated transmission signal to the wireless communication circuit 42 of the apparatus body 41. As the carrier modulation method, for example, amplitude shift keying (ASK), phase shift keying (PSK), quadrature phase shift keying (QPSK), 16 quadrature amplitude modulation (16QAM), or the like is used.

The communication controller 34 controls the wireless communication circuit 21 such that the ultrasound image signal is transmitted with a transmission radio field intensity set by the probe controller 37.

The light emission controller 35 controls the light emission of the light-emitting unit 14 disposed on the outer surface of the third side plate portion S3 of the housing 12 such that various states of the ultrasound probe 11 are represented, under the control of the probe controller 37.

In a case in which the ultrasound probe 11 is disposed in a charger described later, the charging controller 36 controls charging of the battery 16 via the power receive coil 17 with respect to the battery 16 and the power receive coil 17 built in the housing 12.

The temperature sensors 22 disposed inside the housing 12 detect a temperature inside the housing 12, particularly, a temperature in the vicinity of the inner surface of the second side plate portion S2 of the grip portion 12C, and sends the detected temperature to the probe controller 37.

The light-emitting unit 14 is configured by, for example, a light source such as a light emitting diode (LED) lamp or an electroluminescence (EL) lamp, and emits light under the control of the light emission controller 35. In addition, since the light-emitting unit 14 has a structure that extends in an elongated shape in the Y direction, the light-emitting unit 14 can also be configured by a plurality of LED lamps or EL lamps arranged in the Y direction.

The battery 16 supplies the power to each unit in the ultrasound probe 11.

The probe controller 37 performs control of each unit in the ultrasound probe 11 based on a program or the like stored in advance.

The wireless communication circuit 42 of the apparatus body 41 includes an antenna for transmitting and receiving radio waves, and performs wireless communication with the wireless communication circuit 21 of the ultrasound probe 11. In this case, the wireless communication circuit 42 of the apparatus body 41 receives, for example, a transmission signal wirelessly transmitted from the wireless communication circuit 21 of the ultrasound probe 11 through the antenna, demodulates the received transmission signal, and outputs the ultrasound image signal. The wireless communication circuit 42 of the apparatus body 41 sends the ultrasound image signal output in this way to the display controller 43.

The display controller 43 performs predetermined processing on the ultrasound image signal sent from the wireless communication circuit 42 under the control of the body controller 46, and displays the ultrasound image on the monitor 44.

The monitor 44 displays the ultrasound image under the control of the display controller 43, and includes, for example, a display device such as a liquid crystal display (LCD) or an organic electroluminescence display (organic EL display).

The communication controller 45 controls the wireless communication circuit 42 of the apparatus body 41 such that the wireless communication circuit 42 receives the transmission signal from the wireless communication circuit 21 of the ultrasound probe 11.

The body controller 46 controls each unit of the apparatus body 41 based on a program stored in advance and an operation by the user via the input device 47.

The input device 47 is an input device for the user to perform an input operation, and is configured by, for example, a device such as a keyboard, a mouse, a trackball, a touchpad, and a touch sensor disposed in a state of being superimposed on the monitor 44.

In the present embodiment, each processing is executed by any computer. Moreover, any computer may execute these processes by a processor as hardware, a program as software, or a combination thereof. In such a case, the processor is configured to execute various types of processing according to the present embodiment in cooperation with the program, and can function as each unit or each means in the present embodiment. Further, the execution order of the processing by the processor is not limited to the above-described order and may be changed as appropriate. Any computer may be a general-purpose computer, a computer for specific use, a workstation, or another system capable of executing each processing.

Here, each of the processor 38 on the ultrasound probe 11 side and the processor 48 on the apparatus body 41 side may be configured by one or a plurality of types of hardware, and the type of the hardware is not limited. For example, the processor may be configured by hardware such as a central processing unit (CPU), a micro processing unit (MPU), a programmable logic device such as a field programmable gate array (FPGA), a dedicated circuit such as an application specific integrated circuit (ASIC) for executing specific processing, a graphic processing unit (GPU), or a neural processing unit (NPU). Moreover, the type of hardware may be a combination of different types of hardware. In a case in which a plurality of types of hardware are configured to execute one or a plurality of types of processing of a certain processor, the plurality of types of hardware may exist in devices physically separated from each other or may exist in the same device. Further, in any embodiment, the order of each processing executed by the processor is not limited to the above-described order, and may be changed as appropriate. The hardware is configured by an electric circuit (circuitry) in which circuit elements, such as semiconductor elements, are combined, or the like.

In the first embodiment, the processor 38 on the ultrasound probe 11 side is configured by two integrated circuits 19 and 20 shown in FIG. 4.

Furthermore, the program may be software such as firmware or a microcode. The program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media present in devices physically separated from each other. The program code or the code segment may represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents in the memory.

In a case in which ultrasound diagnosis is performed by the ultrasound diagnostic apparatus shown in FIG. 5, first, under the control of the ultrasound transmission/reception controller 33 of the ultrasound probe 11, ultrasound beams are transmitted into the subject from the plurality of transducers of the transducer array 15 in accordance with the drive signal from the transmission/reception circuit 31. The ultrasound echo from the subject is received by the plurality of transducers of the transducer array 15, and the received signal, which is an analog signal, is output from the plurality of transducers to the transmission/reception circuit 31. The received signal is amplified by the amplifying unit 52 of the transmission/reception circuit 31, is subjected to AD conversion by the AD conversion unit 53, and is subjected to reception focus processing by the beam former 54, so that the sound ray signal is generated, and the sound ray signal is sent from the transmission/reception circuit 31 to the image generation unit 32.

Further, the image generation unit 32 generates the image signal, which is the tomographic image information related to the tissue in the subject, by performing correction of attenuation of the sound ray signal by the distance in accordance with the depth of the reflection position of the ultrasound waves and the envelope detection processing by the signal processing unit 55, the image signal is converted into the image signal in accordance with the normal television signal scanning method by the DSC 56, and the ultrasound image signal is generated by the image processing unit 57 further performing various types of necessary image processing such as gradation processing.

The ultrasound image signal generated in this way is wirelessly transmitted from the wireless communication circuit 21 of the ultrasound probe 11 to the apparatus body 41 and is received by the wireless communication circuit 42 of the apparatus body 41, and then the ultrasound image is displayed on the monitor 44 via the display controller 43.

In a case in which such ultrasound diagnosis is performed, the ultrasound probe 11 wirelessly connected to the apparatus body 41 goes through various operation states. For example, there are various states, such as switching between a stop state and an activation state of the ultrasound probe 11, an imaging state and a standby state during the ultrasound imaging, and a live mode state and a freeze mode state in accordance with the ultrasound imaging mode selection.

In addition, the “imaging state” during the ultrasound imaging represents a state in which the transducer array 15 transmits and receives ultrasound waves, and the “standby state” represents a state in which the transmission and reception of the ultrasound waves are stopped.

Further, the “live mode state” represents a state in which the ultrasound image signal generated by the image generation unit 32 is wirelessly transmitted from the wireless communication circuit 21 in order to display the ultrasound image (video) obtained at a predetermined frame rate on the monitor 44 of the apparatus body 41 in real time, and the “freeze mode state” represents a state in which the transmission and reception of the ultrasound waves are interrupted and the ultrasound image signal stored in a cine memory (not shown) is wirelessly transmitted from the wireless communication circuit 21 in order to display the image (still image) of one frame of the ultrasound image (video) generated in the past on the monitor 44 of the apparatus body 41.

Although these various operation states in the ultrasound probe 11 are controlled by the probe controller 37, a way of emitting light by the light-emitting unit 14 disposed on the outer surface of the housing 12 is controlled by the light emission controller 35 that receives the signal transmitted from the probe controller 37 such that the current state of the ultrasound probe 11 is represented.

As a result, the user can easily and intuitively grasp the operation state of the ultrasound probe 11 only by checking the light emitted from the light-emitting unit 14.

Here, the light emission controller 35 can change a color of the light emitted from the light-emitting unit 14 in accordance with the operation state of the ultrasound probe 11. For example, the light-emitting unit 14 is controlled by the light emission controller 35 such that the light-emitting unit 14 emits light of a predetermined color in a case in which the ultrasound probe 11 is being activated, emits light of a color different from the color indicating that the ultrasound probe 11 is being activated in a case of the imaging state, and emits light of a color different from the color indicating that the ultrasound probe 11 is being activated and the color indicating the imaging state in a case of the standby state.

For example, the light-emitting unit 14 can emit light of a primary color system consisting of any of red, green, or blue in the standby state during the ultrasound imaging and can emit light of a complementary color system with respect to the primary color, that is, a color opposite to the primary color on a so-called color wheel in the imaging state, under the control of the light emission controller 35.

In this way, in order to change the color of the light emitted from the light-emitting unit 14 in accordance with the operation state of the ultrasound probe 11, it is desirable that the light sources such as the LED lamp and the EL lamp constituting the light-emitting unit 14 are configured to emit three primary colors or three complementary colors.

Similarly, even in the live mode state and the freeze mode state in accordance with the ultrasound imaging mode selection, the light emission controller 35 can control the light-emitting unit 14 such that light of different colors is emitted from the light-emitting unit 14.

In addition, the light emission controller 35 can also change a light emission pattern in the light-emitting unit 14 in accordance with the operation state of the ultrasound probe 11. For example, the light-emitting unit 14 is controlled by the light emission controller 35 such that the light-emitting unit 14 emits light of a predetermined pattern in a case in which the ultrasound probe 11 is being activated, emits light of a pattern different from the pattern indicating that the ultrasound probe 11 is being activated in a case of the imaging state, and emits light of a pattern different from the pattern indicating that the ultrasound probe 11 is being activated and the pattern indicating the imaging state in a case of the standby state. It is assumed that light of the same color is emitted in these light emission patterns.

For example, the light-emitting unit 14 can emit light in an on-state pattern in which light is continuously emitted in a case in which the ultrasound probe 11 is being activated, emit light in a blinking pattern having a predetermined blinking rate in a case of the imaging state, and emit light in a blinking pattern having a slower blinking rate than the blinking pattern indicating the imaging state in a case of the standby state, under the control of the light emission controller 35.

As the light emission pattern in the light-emitting unit 14, for example, a so-called Morse code used for a signal lamp of a ship or the like can be adopted. A configuration may be adopted in which a blinking interval of the light emitted from the light-emitting unit 14 is controlled to emit variable-length coded light signals.

Similarly, even in the live mode state and the freeze mode state in accordance with the ultrasound imaging mode selection, the light emission controller 35 can control the light-emitting unit 14 such that the light-emitting unit 14 emits light in a different pattern.

In addition, the light emission controller 35 can also change both the color of the light emitted from the light-emitting unit 14 and the light emission pattern in accordance with the operation state of the ultrasound probe 11. As a result, the user can more easily and intuitively grasp various states.

For example, a configuration can be adopted in which the light emission is not performed in a case of power-off, blinking in blue is performed during the establishment work of the wireless connection, light is turned on in blue after the establishment of the wireless connection is completed, light is turned on in yellow in a case in which the remaining capacity of the battery 16 is decreased, light is turned on in orange in a case of failure, light is turned on in white in a case of B-mode imaging during live, light is turned on in purple in a case of color Doppler imaging, light is turned on in brown in a case of power Doppler imaging, light is turned on in pink in a case of M-mode imaging, and blinking in the same color as the color of each imaging is performed during freeze.

Alternatively, a configuration can be adopted in which the light emission is not performed in a case of power-off, blinking in green is performed during the establishment work of the wireless connection, light is turned on in green after the establishment of the wireless connection is completed, light is turned on in blue in a case in which the remaining capacity of the battery 16 is decreased, high-rate blinking in blue is performed in a case of failure, light is turned on in cyan in a case of B-mode imaging during live, light is turned on in magenta in a case of color Doppler imaging and power Doppler imaging, light is turned on in yellow in a case of M-mode imaging, and blinking in the same color as the color of each imaging is performed during freeze.

Further, a configuration may be adopted in which light is turned on in cyan in a case of B-mode imaging during live, the light emission using the Morse code is performed in a case of color Doppler imaging and power Doppler imaging, light is turned on in yellow in a case of M-mode imaging, and blinking in the same color as the color of each imaging is performed during freeze.

In addition, a configuration may be adopted in which the light emission is not performed in a case of power-off, blinking in purple is performed during the establishment work of the wireless connection, light is turned on in purple after the establishment of the wireless connection is completed, turning on light in purple and blinking are alternately performed in a case in which the remaining capacity of the battery 16 is decreased, high-rate blinking in purple is performed in a case of failure, and the light emission using the Morse code is performed during live and during freeze.

The light emission controller 35 can also control the light-emitting unit 14 such that the way of emitting light is changed in accordance not only with the operations directly related to the ultrasound imaging, such as the imaging state and the standby state in the ultrasound imaging, the live mode state and the freeze mode state in accordance with the ultrasound imaging mode selection, but also with, for example, a wireless connection state between the ultrasound probe 11 and the apparatus body 41, a remaining capacity of the battery 16, an error state, and an update state of software installed in the ultrasound probe 11.

In addition, the temperature of the vicinity of the inner surface of the second side plate portion S2 of the grip portion 12C detected by the two temperature sensors 22 is transmitted to the probe controller 37, and the notification of a heat generation state of the ultrasound probe 11 can be performed by the light emitted from the light-emitting unit 14 under the control of the light emission controller 35.

In general, the surface temperature of the ultrasound probe is limited to a temperature equal to or lower than a temperature predetermined by a safety standard, but, in a case in which the way of the light emission of the light-emitting unit 14 is changed in accordance with the temperature detected by the temperature sensor 22, the user can easily and intuitively grasp the surface temperature of the ultrasound probe 11, so that the temperature can be suppressed to be equal to or less than the predetermined temperature.

In a case in which the temperature detected by the temperature sensors 22 has reached a predetermined threshold value, the surface temperature of the ultrasound probe 11 can be lowered by performing a treatment such as adjusting the drive signal supplied from the transmission/reception circuit 31 to the transducer array 15 by the ultrasound transmission/reception controller 33 to lower the frame rate of the ultrasound imaging or stopping the ultrasound imaging.

As shown in FIG. 2, the grip portion 12C of the housing 12 has the width W1 narrower than the maximum width W2 of the head portion 12A in the X direction, and the light-emitting unit 14 is disposed on the outer surface of the grip portion 12C on the +X direction side. Therefore, in a case in which the head portion 12A of the ultrasound probe 11 is directed toward the body surface of the subject in order to perform the ultrasound diagnosis, the light emitted from the light-emitting unit 14 is less likely to enter the eyes of the subject since the light-emitting unit 14 is hidden behind the head portion 12A, and thus it is possible to reduce the subject's sense of glare.

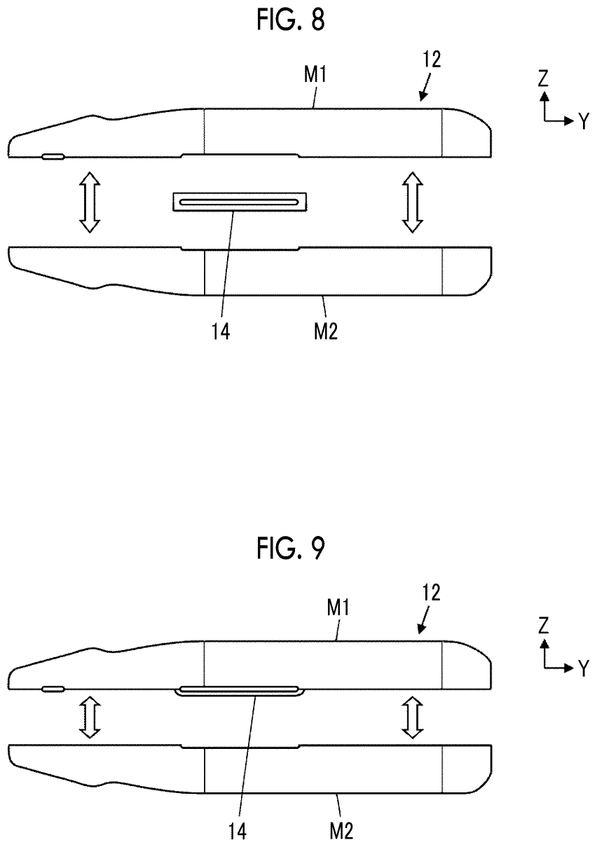

As shown in FIG. 8, the housing 12 of the ultrasound probe 11 is formed by bonding a front-side half member M1 disposed on the +Z direction side to a rear-side half member M2 disposed on the −Z direction side.

The light-emitting unit 14 can be formed as a separate component from the front-side half member M1 and the rear-side half member M2 with respect to such a housing 12, and can be disposed at a boundary portion between the front-side half member M1 and the rear-side half member M2 to bond the front-side half member M1 to the rear-side half member M2.

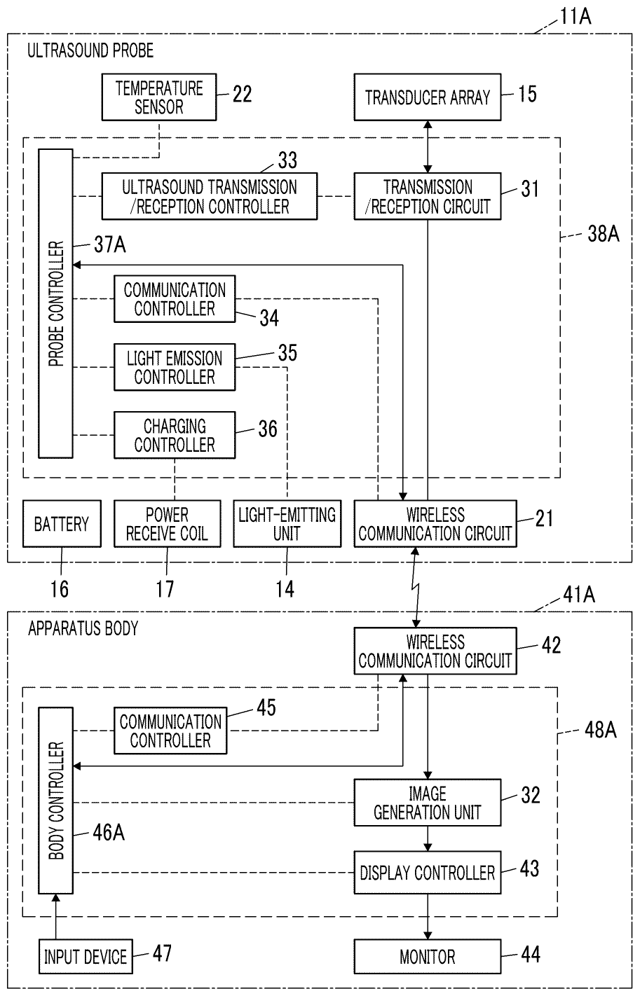

Alternatively, as shown in FIG. 9, the light-emitting unit 14 can be integrally formed in advance on one of the front-side half member M1 or the rear-side half member M2, for example, the front-side half member M1, and the front-side half member M1 and the rear-side half member M2 can be bonded to each other.

In the ultrasound probe 11, since the outer surface of the second side plate portion S2 disposed on the side opposite to the first side plate portion S1 with the center line C1 interposed therebetween among the first side plate portion S1 to the fourth side plate portion S4 surrounding the grip portion 12C has at least a part of a curved shape, the user can easily grip the grip portion 12C, and the operability of the ultrasound probe 11 is improved.

In addition, since the protrusion 13 is formed to protrude on the +X direction side of the head portion 12A of the ultrasound probe 11, the user can easily grasp the orientation of the ultrasound probe 11 due to the presence of the protrusion 13 in a case in which the user grips the grip portion 12C.

Further, as shown in FIG. 2, the light-emitting unit 14 is disposed to protrude toward the +X direction side with respect to the outer side surface of the third side plate portion S3 of the grip portion 12C on the same +X direction side as the protrusion 13. Therefore, the user can grasp the orientation of the ultrasound probe 11 by only gripping the grip portion 12C and touching the grip portion 12C to the light-emitting unit 14, and can easily check the light emitted from the light-emitting unit 14 while gripping the grip portion 12C, and thus the operability of the ultrasound probe 11 is improved.

The light-emitting unit 14 need not always protrude to the +X direction side with respect to the outer side surface of the third side plate portion S3 of the grip portion 12C, and may be disposed to form the same surface as the outer side surface of the third side plate portion S3, or may be disposed to be recessed in the −X direction side with respect to the outer side surface of the third side plate portion S3.

In the ultrasound probe 11 of the first embodiment, the protrusion 13 is formed to protrude on the +X direction side of the head portion 12A, and the light-emitting unit 14 is disposed on the +X direction side of the grip portion 12C, but the present invention is not limited to this, and the protrusion 13 can be formed to protrude on the −X direction side of the head portion 12A of the ultrasound probe 11, and the light-emitting unit 14 can be disposed on the −X direction side of the grip portion 12C.

In addition, a light diffusion plate can also be disposed on the front surface of the light-emitting unit 14. In this way, in a case in which the light-emitting unit 14 is composed of the plurality of LED lamps or EL lamps arranged in the Y direction, even in a case in which the number of LED lamps or EL lamps to be arranged is small, the entire light diffusion plate can be made to emit light during light emission.

### Second Embodiment

The ultrasound probe 11 according to the first embodiment includes the image generation unit 32, and the ultrasound image signal generated by the image generation unit 32 is wirelessly transmitted from the wireless communication circuit 21 of the ultrasound probe 11 to the apparatus body 41 as shown in FIG. 5, but the present invention is not limited to this.

FIG. 10 shows a configuration of an ultrasound diagnostic apparatus comprising an ultrasound probe 11A according to a second embodiment. The ultrasound diagnostic apparatus comprises the ultrasound probe 11A and an apparatus body 41A according to the second embodiment, and the ultrasound probe 11A and the apparatus body 41A are connected to each other by wireless communication.

The ultrasound probe 11A is obtained by deleting the image generation unit 32 in the ultrasound probe 11 according to the first embodiment shown in FIG. 5, directly connecting the wireless communication circuit 21 to the transmission/reception circuit 31, and using a probe controller 37A instead of the probe controller 37, and other configurations of the ultrasound probe 11A are the same as those of the ultrasound probe 11 according to the first embodiment. In addition, the ultrasound probe 11A has the same housing 12 as the housing 12 in the ultrasound probe 11 according to the first embodiment.

The apparatus body 41A is obtained by newly connecting the image generation unit 32 between the wireless communication circuit 42 and the display controller 43 in the apparatus body 41 according to the first embodiment shown in FIG. 5, and connecting the body controller 46A to the display controller 43, the communication controller 45, and the image generation unit 32 instead of the body controller 46, and other configurations of the apparatus body 41A are the same as those of the apparatus body 41 according to the first embodiment.

In the ultrasound probe 11A, the transmission/reception circuit 31, the ultrasound transmission/reception controller 33, the communication controller 34, the light emission controller 35, the charging controller 36, and the probe controller 37A form a processor 38A on the ultrasound probe 11A side.

In addition, in the apparatus body 41A, the image generation unit 32, the display controller 43, the communication controller 45, and the body controller 46A form a processor 48A on the apparatus body 41A side.

The sound ray signal generated in the transmission/reception circuit 31 of the ultrasound probe 11A is wirelessly transmitted from the wireless communication circuit 21 to the apparatus body 41A, the image generation unit 32 performs attenuation correction and envelope detection processing on the sound ray signal received by the wireless communication circuit 42 of the apparatus body 41A to generate the ultrasound image signal, and the ultrasound image is displayed on the monitor 44 via the display controller 43.

In this way, in the ultrasound diagnostic apparatus comprising the ultrasound probe 11A according to the second embodiment as well, the ultrasound image can be displayed on the monitor 44 in the same manner as the ultrasound diagnostic apparatus comprising the ultrasound probe 11 according to the first embodiment.

In addition, in the ultrasound probe 11A according to the second embodiment as well, similarly to the ultrasound probe 11 according to the first embodiment, the light-emitting unit 14 is controlled by the light emission controller 35 to perform the light emission in a way corresponding to the operation state of the ultrasound probe 11. As a result, the user can easily and intuitively grasp the operation state of the ultrasound probe 11A only by checking the light emitted from the light-emitting unit 14.

The apparatus body 41 according to the first embodiment and the apparatus body 41A according to the second embodiment may have a portable thin computer form or may be a stationary apparatus body.

### EXPLANATION OF REFERENCES

11, 11A: ultrasound probe
12: housing
12A: head portion
12B: rear end portion
12C: grip portion
13: protrusion
14: light-emitting unit
15: transducer array
15A: acoustic lens
16: battery
17: power receive coil
18: circuit board
19, 20: integrated circuit
21, 42: wireless communication circuit
22: temperature sensor
23: heat dissipation member
23A: opening portion
31: transmission/reception circuit
32: image generation unit
33: ultrasound transmission/reception controller
34, 45: communication controller
35: light emission controller
36: charging controller
37, 37A: probe controller
38, 38A, 48, 48A: processor
41, 41A: apparatus body
43: display controller
44: monitor
46, 46A: body controller
47: input device
51: pulser
52: amplifying unit
53: AD conversion unit
54: beam former
55: signal processing unit
56: DSC
57: image processing unit
C1: center line
S1: first side plate portion
S2: second side plate portion
S3: third side plate portion
S4: fourth side plate portion
W1. W2: width
M1: front-side half member
M2: rear-side half member

What is claimed is:

1. An ultrasound probe as a wireless-connection ultrasound probe, the ultrasound probe comprising:
a transducer array;
a light-emitting unit;
a light emission controller that controls light emission performed by the light-emitting unit;
a battery that supplies power to the light-emitting unit and the light emission controller; and
a housing that accommodates the transducer array, the light emission controller, and the battery,
wherein the housing includes a head portion that accommodates the transducer array, and a grip portion that is connected to the head portion and that is gripped by a user,
a protrusion for indicating an orientation of the ultrasound probe is disposed on an outer side surface of the head portion,
the light-emitting unit is disposed on an outer side surface of the grip portion on the same side as the outer side surface of the head portion on which the protrusion is disposed, and
the light emission controller controls the light-emitting unit to perform the light emission in a way in accordance with an operation state of the ultrasound probe.

2. The ultrasound probe according to claim 1,
wherein the light emission controller changes a color of light emitted from the light-emitting unit in accordance with the operation state of the ultrasound probe.

3. The ultrasound probe according to claim 2,
wherein the light emission controller causes the light-emitting unit to emit light of a primary color system during imaging standby and light of a complementary color system during imaging.

4. The ultrasound probe according to claim 1,
wherein the light emission controller changes a light emission pattern in the light-emitting unit in accordance with the operation state of the ultrasound probe.

5. The ultrasound probe according to claim 2,
wherein the light emission controller changes a light emission pattern in the light-emitting unit in accordance with the operation state of the ultrasound probe.

6. The ultrasound probe according to claim 3,
wherein the light emission controller changes a light emission pattern in the light-emitting unit in accordance with the operation state of the ultrasound probe.

7. The ultrasound probe according to claim 4,
wherein the light emission controller changes the light emission pattern in the light-emitting unit between a live mode and a freeze mode of imaging.

8. The ultrasound probe according to claim 5,
wherein the light emission controller changes the light emission pattern in the light-emitting unit between a live mode and a freeze mode of imaging.

9. The ultrasound probe according to claim 6,
wherein the light emission controller changes the light emission pattern in the light-emitting unit between a live mode and a freeze mode of imaging.

10. The ultrasound probe according to claim 1,
wherein a portion of the grip portion in which the light-emitting unit is disposed has a width narrower than a width of the head portion.

11. The ultrasound probe according to claim 2,
wherein a portion of the grip portion in which the light-emitting unit is disposed has a width narrower than a width of the head portion.

12. The ultrasound probe according to claim 3,
wherein a portion of the grip portion in which the light-emitting unit is disposed has a width narrower than a width of the head portion.

13. The ultrasound probe according to claim 4,
wherein a portion of the grip portion in which the light-emitting unit is disposed has a width narrower than a width of the head portion.

14. The ultrasound probe according to claim 5,
wherein a portion of the grip portion in which the light-emitting unit is disposed has a width narrower than a width of the head portion.

15. The ultrasound probe according to claim 6,
wherein a portion of the grip portion in which the light-emitting unit is disposed has a width narrower than a width of the head portion.

16. The ultrasound probe according to claim 7,
wherein a portion of the grip portion in which the light-emitting unit is disposed has a width narrower than a width of the head portion.

17. The ultrasound probe according to claim 8,
wherein a portion of the grip portion in which the light-emitting unit is disposed has a width narrower than a width of the head portion.

18. The ultrasound probe according to claim 1,
wherein the housing is formed of a front-side half member and a rear-side half member that are bonded to each other, and the light-emitting unit consists of a separate component from the front-side half member and the rear-side half member and is disposed at a boundary portion between the front-side half member and the rear-side half member.

19. The ultrasound probe according to claim 1,
wherein the housing is formed of a front-side half member and a rear-side half member that are bonded to each other, and the light-emitting unit is integrally formed with one of the front-side half member or the rear-side half member.

20. The ultrasound probe according to claim 1, further comprising:
an integrated circuit that performs transmission and reception of ultrasound waves using the transducer array,
wherein the integrated circuit is accommodated in the housing and is operated by the power supplied from the battery.
